(19) United States
(12) Patent Application Publication
(10) Pub. No.: US 2026/0127929 A1
(43) Pub. Date: May 7, 2026

(54) PROXIMITY CARD ADDON

(71) Applicant: BOEKIT B.V., BOXTEL (NL)

(72) Inventors: Johannes Hermanus Petrus Maria OONK, BOXTEL (NL); Petrus Joannes Wilhelmus VAN HERP, BOXTEL (NL)

(21) Appl. No.: 19/120,656

(22) PCT Filed: Oct. 13, 2023
(86) PCT No.: PCT/NL2023/050538

§ 371 Date: Apr. 11, 2025

(30) Foreign Application Priority Data
Oct. 14, 2022 (NL) 2033317

(51) Int. Cl. G07C 9/29; G06K 7/10; G07C 9/27

(52) U.S. Cl. CPC G07C 9/29; G06K 7/10297; G07C 9/27

(57) ABSTRACT

The present disclosure relates to a proximity card arrangement, comprising: a proximity card comprising electronic means for communication with a card reader to provide authorization data of a user of said card to a restricted area; and said card arrangement further comprising: a proximity card addon, comprising electronic communication means, arranged for communicating with said proximity card to obtain said authorization data to identify said user, and for communicating with a mobile user equipment for providing personal facility management services to said user of said mobile user equipment.

### TECHNICAL FIELD

The present invention relates in general to a smart proximity card to provide physical access to a restricted area.

More in particular relates the present invention to a method of and device for providing such physical access to a restricted area in which the proximity card is a conventional type of proximity card which is upgradable to a smart type of proximity card.

### BACKGROUND

In offices but also in many other facilities such as schools, access may be restricted for certain areas. Only authorized persons may enter such restricted areas. These persons are provided with access authorizations means such as a key or typically a proximity card.

In accordance with the present invention, a proximity card is to be interpreted as a chip card or integrated circuit card, ICC or IC card, or any physical electronic authorization device which is used to control access to a resource, typically a room or area. Typically, the proximity card is a plastic card, having a certain standardized size, e.g. a credit card size or ID-1 ISO/IEC7810 dimension. Such proximity cards control authorization, which is not the same as authentication as the authorization may be provided on an anonymous basis. Persons may be given access to a certain area through a proximity card having a certain code which might either be unique for each card and thus each person, or may be general, comparable with a conventional key in which any person may have a dedicated unique key to allow access to an area, or may all have copies of the same key to gain access. Proximity cards may be fully passive and may be active, and may comprise simple electronic authentication means such as a magnetic strip comprising authorization data or an integrated circuit comprising such authorization data or having a (distinct) memory which can be accessed to comprise the authorization data.

Proximity cards are widespread and widely used as the most common type of authorization means for gaining access to restricted areas. In most office buildings each employee has a general or personal proximity card to gain access to the building and/or to specific areas, floors, or rooms of the building based on the level of clearance the person has.

With an authorized proximity card the employee may gain access but this is only one aspect of the facilities that he or she may need within the building or even in the close proximity of the building. Access to a parking garage may for example be arranged through a separate system which requires a separate type of authorization. Throughout the building further facilities may require additional and separate systems. Coffee may for example be provided free of charge for (some) employees but not for visitors or for everybody, which may require some sort of token-based system on the coffee-machine.

Having separate systems for all available facilities including the access authorization is considered cumbersome and inefficient. Most of these facility services may be provided through a more user-friendly application on a mobile phone, but mobile phones are not considered suitable for providing access to a building, as they may require more complex and expensive readers, and due to hardware incompatibility as not all mobile phones have the same hardware, access cannot be guaranteed. Hence, there is a need to provide an access authorization system which is simple and backwards compatible with typical access authorization systems but which is more convenient and intuitive for other facility services.

Moreover, the there is tendency to collect data from all wireless devices within the restricted access area. Typically, such restricted areas have a large number of connected devices like coffee machines, printers, smart lighting systems, computers, desk phones, time attendance systems, Point-of-Sale (POS) systems, smart lockers, network storage systems, servers, etc. etc. All or at least many of these devices may be arranged for wireless communication, and al lot for wireless communication of a wireless personal area network, WPAN such as Bluetooth or the like. There can be many different advantages in collecting data by a mobile user equipment such as a smartphone from any one or more of these devices, for example for inventory management, POS systems, asset tracking, employee time and attendance systems, customer tracking, customer analytics, climate control, facility management, conference room booking, or more in general location based services.

Before a smartphone or the like can establish a connection with any of these devices over a WPAN connection such as Bluetooth, typically, there needs to be a pairing between both devices firstly. Pairing however requires the smartphone to be in an active scanning mode. Such scanning modes draw relatively large amounts of power from the battery of the smartphone and thus may drain the smartphone. To this end, most smartphones limit such scanning and typically require user actions to initiate such scanning mode. Automatic and background type of active scanning is typically not allowed or possible. Hence, collecting data from any of these devices in the area by the mobile phone cannot be done automatically. There is a need for such automatic data collection without the user manually activating the active scanning mode of the WPAN communication.

### SUMMARY OF THE INVENTION

In a first aspect, there is provided a proximity card addon having a ISO/IEC7810 type ID-1formfactor, and arranged to be attached to a proximity card, said proximity card comprising:
a chargeable battery;
primary communication means, arranged for communication with a proximity card, wherein said proximity card comprising communication means arranged for Near Field Communication, NFC, with a card reader to exchange authorization data of a user of said card to a restricted area;
secondary communication means, arranged for communication with a mobile user equipment such as a mobile phone and devices within said restricted area through Wireless Personal Area Network, WPAN, communication with said mobile user equipment and said devices in said restricted area;
a controller, arranged for control of said primary and said secondary communication means, and to operate said secondary communication means in an active scanning mode, for transmitting inquiry message and receiving response messages from said devices in said restricted area, wherein said controller is further arranged for transmitting to said mobile user equipment said response messages from said devices in said restricted area.

The present invention provides a proximity card addon, meaning that a device is provided with form factor equal or at least approximately equal to a proximity card, such that it can be attached thereto easily, for example with a shield or guard or type of housing in which both the addon and the proximity card itself can be contained.

The proximity card may preferably be any type of conventional access card comprising any type of electronic means for communication with a card reader. The proximity card may thus be a card such as an access badge or a smart access cart or smartcard. The card may comprise a magnetic stripe, barcode, or biometric means to exchange biometric information with the reader. Preferably the proximity card is arranged for Near Field Communication, NFC, and to this end has a NFC chip.

The proximity card is arranged to communicate with a reader. The reader may be smart reader arranged for wireless or contactless communication or for contact based communication. The proximity card has a storage medium to comprise the authorization data. The storage medium may preferably be an electronic storage means such as a memory or a register of an electronic circuit.

The authorization data may be stored on the proximity card as a code or a token. The data may be stored and communicated as a digital signal or as an analogue signal, for example an LC-circuit. The authorization data may be used as a facility code in which a whole facility may be accessed based on a single code or a site code. In such case, each and every proximity card holds the same authorization data. Alternatively, each card may also have a distinct, unique code which is associated with the user to allow personal access restrictions or clearance to the restricted area.

Preferably, the proximity card is a smart card type of proximity card in which the card comprises an embedded integrated circuit with a memory. A smart proximity card has the advantage that it enables additional services such as an incorporated wallet function, membership data and combined access control to or for the restricted area.

The smart card type of proximity card may be radio-based, having Radio Frequency communication means to communicate with the reader, and may use typical radio bands such as 13.56 MHz or 125 kHz. Higher frequencies may allow higher bandwidth, but typically require more short-range communication between card and reader.

The proximity card addon according to the present disclosure is characterized having a battery, which is chargeable and preferably comprises means for QI or other type of wireless charging. The addon has a primary and secondary communication means. The primary is arranged for communication with the proximity card and to this end preferably is arranged for NFC communication to exchange authorization data of a user of said card to a restricted area. The secondary is arranged for communication with the mobile user equipment, e.g. mobile phone but also for communication with all or at least some of the devices within the restricted area. The secondary is arranged for communication over a Wireless Personal Area Network, WPAN, communication channel with thus both the mobile phone and the devices.

The addon further has a controller, arranged for control of the primary and the secondary communication means. The controller operates the secondary communication means in an active scanning mode. This way the controller may transmit inquiry message to the devices in the room or area and receiving response messages from those devices. This data generated in one or more of the inquiry and response messages, and further data exchanged between both devices, is transmitted to the mobile user equipment, such that the data is collected and can be used for one or more of an inventory management, POS systems, asset tracking, employee time and attendance systems, customer tracking, customer analytics, climate control, facility management, conference room booking, or more in general location based services, for example based on the detected location of the user. For example, as soon as the user's proximity card is read by a card reader, a backend server may store the current location of the user in a database. On the basis of the location, defined by restricted area zones, together with a building plan of the building in which these zones are defined, and a list of services associated with the zones, the user may be services with certain services, and communication for, and regarding service may be established through the mobile user equipment of the user.

In the context of the present description, the application of out-of-band (OOB) communication on the primary communication means may be used to enable establishing a secure connection over the secondary communication channel. OOB communication involves using a separate, trusted channel to initiate, authenticate, and pair devices before the secondary communication channel is established. This additional layer of security and validation enhances the overall integrity of the connection.

With the addon card, the primary communication means, which is based on NFC, can utilize OOB communication to ensure the authenticity and trustworthiness of the devices involved. OOB communication can be used to initiate the connection between the proximity card addon and the mobile user equipment, such as a mobile phone, during the initial setup or pairing process. This OOB data could be exchanged through a secure and separate channel, like Bluetooth or a dedicated app, to ensure that only authorized devices can initiate the pairing process.

Furthermore, OOB communication may also be employed to authenticate both the proximity card addon and the mobile user equipment, using cryptographic keys, digital certificates, or other secure data. This authentication is beneficial in preventing unauthorized access and ensuring the privacy and security of data exchanged over the secondary communication channel.

Additionally, OOB communication can facilitate the exchange of encryption keys, ensuring that data transmitted between the proximity card addon and the mobile device is encrypted and protected against eavesdropping or tampering. By establishing trust and security through OOB communication on the primary communication means, the patent claim enhances the connection's reliability, especially in scenarios involving sensitive or confidential data, such as access control to a restricted area. This solution provides robust security and access control for various environments, including offices and retail stores, where secure data exchange is paramount.

In an example, said controller is arranged for Out-of-Band communication.

In an example, said controller is arranged for Out-Of-Band communication wherein controller establishes a first communication channel over said primary communication means, initiating establishing a second communication channel over said secondary communication means, to exchange data between said mobile user equipment and said devices in said restricted area.

In an example, said first communication channel is established as an NFC channel, by said proximity card addon to be in close proximity with said mobile user equipment.

In an example, said controller is further arranged for transmitting to said mobile user equipment said received authorization data from said proximity card

In an example, said addon further comprising:
a charging unit, in electronic communication with said chargeable battery and said controller, and arranged for wireless charging of said chargeable battery.

In an example, said controller is further arranged for transmitting to said mobile user equipment said authorization data of said user of said card to said restricted area, received through said primary communication means.

In an example, said primary and secondary communication means are integrated into a single communication unit arranged for establishing a primary communication channel with said proximity card, and a secondary communication channel with said mobile user equipment and with said devices in said restricted area.

In a second aspect, there is provided a proximity card arrangement, comprising:
a proximity card comprising electronic means for communication with a card reader to provide authorization data of a user of said card to a restricted area; and said card arrangement further comprising:
a proximity card addon, comprising electronic communication means, arranged for communicating with said proximity card to obtain said authorization data to identify said user, and for communicating with a mobile user equipment for providing personal facility management services to said user of said mobile user equipment.

In this second aspect, the present disclosure provides a proximity card arrangement, meaning that the arrangement is comprised of at least two main components, one of the components being a conventional proximity card. The proximity card may preferably be any type of conventional access card comprising any type of electronic means for communication with a card reader. The proximity card may thus be a card such as an access badge or a smart access cart or smartcard. The card may comprise a magnetic stripe, barcode, or biometric means to exchange biometric information with the reader.

The proximity card is arranged to communicate with a reader. The reader may be smart reader arranged for wireless or contactless communication or for contact based communication. The proximity card has a storage medium to comprise the authorization data. The storage medium may preferably be an electronic storage means such as a memory or a register of an electronic circuit.

The authorization data may be stored on the proximity card as a code or a token. The data may be stored and communicated as a digital signal or as an analogue signal, for example an LC-circuit. The authorization data may be used as a facility code in which a whole facility may be accessed based on a single code or a site code. In such case, each and every proximity card holds the same authorization data. Alternatively, each card may also have a distinct, unique code which is associated with the user to allow personal access restrictions or clearance to the restricted area.

Preferably, the proximity card is a smart card type of proximity card in which the card comprises an embedded integrated circuit with a memory. A smart proximity card has the advantage that it enables additional services such as an incorporated wallet function, membership data and combined access control to or for the restricted area.

The smart card type of proximity card may be radio-based, having Radio Frequency communication means to communicate with the reader, and may use typical radio bands such as 13.56 MHz or 125 kHz. Higher frequencies may allow higher bandwidth, but typically require more short-range communication between card and reader.

The proximity card assembly according to the present disclosure is characterized by the a proximity card addon. The proximity card addon may be manufactured of a plastic or other suitable material and preferably has the same or at least corresponding dimensions of the proximity card. Typically, the proximity card may have a credit card size in accordance with ID-1 ISO/IEC7810, and preferably, the proximity card addon has the same dimensions. The addon may be provided with a layer of adhesive which is disposed on one of the main surfaces of the addon. The adhesive is preferably an adhesive tape on which the proximity card may be placed and attached. The addon may be arranged for a keycord or the like for the users convenience.

The addon is arranged for communication with the proximity card and communication with a mobile user equipment. The communication with the proximity card enables that the arrangement has become personal and that the identity of the user of the proximity card addon is associated with the proximity card. The communication with the mobile user equipment such, e.g. a smart phone, enables a software application running on the smart phone or through a web interface on a browser of the smart phone, to be associated with the proximity card.

This association of software application on the smart phone with the proximity card and in particular the user of the proximity card and thus the authorization data arranged for user identification, allows personal, intuitive, and convenient facility services which services can not only be provided on a personal level, e.g. ordering lunch while respecting allergies and diet requirements for example, but also personal preferences relating drinks, but is also enables that these services may be provided on the basis of location of the user as the presence within the building may be determined and preferably also an accurate location within the building if there are several restricted areas and corresponding proximity card readers within the building.

The arrangement allows different types of facility services which can be provided on a personal and preferably location based service. Examples thereof are reserving a meeting room, requesting help from a medic, fireman, IT service specialist, or a waiter or cleaner.

When for example an employee within a building has spilled coffee, he or she may conventionally notice a facility service employee to call a cleaner, or even use an application based service in which he or she can order a cleaner or issue a ticket for a cleaner. This is however cumbersome as the conventional route requires presence of a facility service employee or a ticket registration system in which all kinds of information is mandatory and requested from the user, such as the credentials to allow access to the ticket system, the credentials to identify the user registering the ticket, the service to which the ticket applies, location information within the building to which the ticket applies, etc. This type of facility service ticketing is considered cumbersome, complex and non-intuitive, whereas associating the proximity card to a smart phone or other mobile user equipment running a facility service application, is intuitive and simple as most of mandatory information such as user credentials and location information can be provided automatically. The proximity card addon enables such association, but without modification to the proximity card such that there are no restrictions to the use of certain hardware or the complex and expensive modification or upgrade of the readers within the building. The presented arrangement is backwards compatible with conventional, simple, robust and cheap proximity card access systems, whereas the addon upgrades the conventional proximity card to a smart card having all capabilities within the digital domain.

The present arrangement also enables automatic location-based services based on the detected location of the user. As soon as the user's proximity card is read by a card reader, a backend server may store the current location of the user in a database. On the basis of the location, defined by restricted area zones, together with a building plan of the building in which these zones are defined, and a list of services associated with the zones, the user may be services with certain services, and communication for, and regarding service may be established through the mobile user equipment of the user.

In an example, the electronic communication means of said proximity card addon means comprise a Radio Frequency, RF based wireless communication means arranged for communication with said mobile user equipment.

In an example, the electronic means of said proximity card comprise a Radio Frequency, RF based wireless communication means arranged for communication with said mobile user equipment.

In an example, the RF based wireless communication means comprises a NFC communication means arranged for communication with said mobile user equipment or said card reader.

In an example, the RF based wireless communication means comprises an RFID communication means arranged for communication with said mobile user equipment or said card reader

In an example, the RF based wireless communication means is arranged for wireless personal area network communication with said mobile user equipment, and in particular, wherein said wireless personal area network is a Bluetooth or Bluetooth LE communication protocol, for communication with said mobile user equipment.

In an example, the authorization data comprises a unique anonymous authentication token.

In an example, the authorization data comprises user authentication credentials, preferably comprising personal identification data.

In an example, the proximity card is a contactless smart card.

In an example, the proximity card is comprised in a smart wearable.

In an example, the proximity card addon has a formfactor corresponding to said proximity card.

In an example, the proximity card has a formfactor in accordance with ISO/IEC7810 type ID-1.

In an example, the proximity card addon comprises a battery, wherein said battery in particular is arranged for charging, and more in particular arranged for wireless charging by an inductive charging station.

In an further aspect, there is provided a method of providing building facility services to a user, said facility services comprising providing access for said user to restricted areas within a building and additional personal building facilities relating to a particular service and location within said building, said method comprising the steps of:
providing a proximity card comprising electronic means for communication with one or a plurality of card readers within said building to provide authorization data of a user of said card to a restricted area beyond said card reader;
providing a proximity card addon, comprising electronic communication means, arranged for communicating with said proximity card to obtain said authorization data to identify said user, and for communicating with a mobile user equipment;
associating said proximity card addon with said proximity card, by processing an enrolment procedure;
enabling a facility management service application, running on said mobile user equipment of said user, to provide personal facility management services to said user of said mobile user equipment on the basis of the determined location of said proximity card, and said user associated through said proximity card.

In an example, the enrolment procedure comprises the steps of:
scanning, with said mobile user equipment, an URL, preferably provided as a QR code on said proximity card addon or provided with said proximity card addon, wherein said URL comprises a unique identifier of said proximity card addon;
associating, with said mobile user equipment, through said URL on a webserver, said proximity card addon with said mobile user equipment.

### BRIEF DESCRIPTION OF THE DRAWINGS

The specific features, aspects and advantages of the present disclosure will become better understood with regard to the following description and accompanying drawings where:

FIG. 1 illustrates an example proximity card, a proximity card addon, and proximity card arrangement according to the present disclosure;

FIG. 2 illustrates a flowchart of an example of the method according to another aspect of the present disclosure;

FIG. 3 illustrates further examples of the proximity card arrangement according to the present disclosure;

FIG. 4 illustrates a user interface of a smart phone running a facility service application arranged for the proximity card arrangement according to the present disclosure.

### DETAILED DESCRIPTION

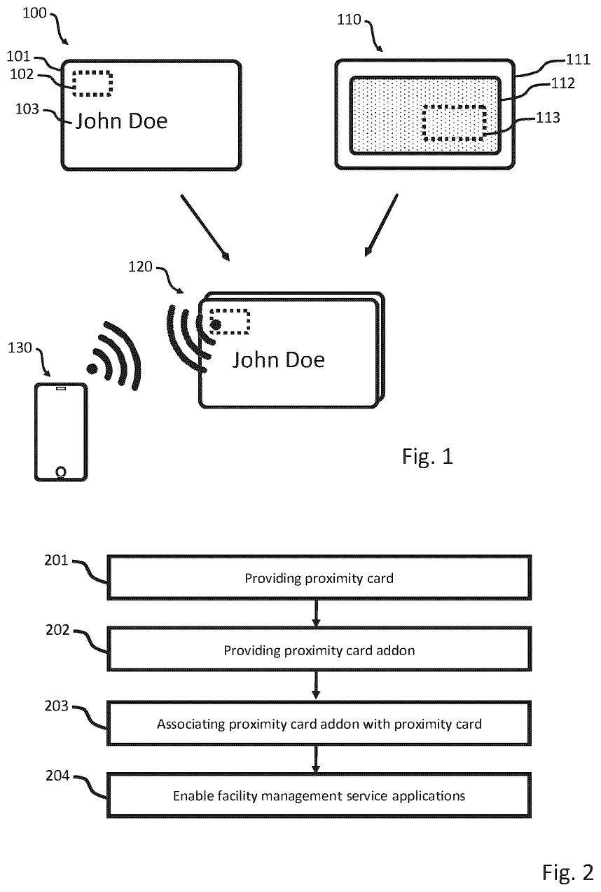

The present disclosure shows in FIG. 1 a proximity card arrangement 102. The arrangement comprises at least two main components, being the proximity card 100 and a proximity card addon 110.

The proximity card 100 may comprise any known type of identity card, credit card, badge or any type of card which is arranged to provide access to a restricted area, for example one or more rooms, areas, offices or floors within an office building. These however are mere examples as the proximity card may also apply to any other restricted area such as a concert hall, open space concert or any type of public transport.

The proximity card 100 has a type of electronic means 112 which is provided in or embedded in a carrier 101 which is the main body 101 of the card. The carrier may is preferably made from plastic or any other suitable material and may have known size or dimension, e.g. a credit card size or a ID-1, ID-2, ID-3 or ID-4 ISO/IEC7810 dimension. In the example shown in FIG. 1, the proximity card is a badge or ID card on which the name of the user 103 is shown. The card is thereby a personal card, and may or may not have personalized authorization data. The authorization data is stored in the electronic means 102 for example in the form of a chip, a RF antenna layout RFID, NFC, barcode, QR-code or magnetic chip.

The proximity card is thus a known access means to gain access to restricted areas. The invention lies in the addition to the proximity card in the form or a proximity card addon 110. The proximity card addon 110 also has a main body 111 made preferably from the same material or similar material as the proximity card itself. The proximity card addon 110 and in particular the main body 111 has preferably approximately the same dimensions and preferably the same form factor. The addon may be a bit thicker as it may comprise more electronic components, e.g. a battery and communication means 113. The communication means 113 are arranged to communicate with a mobile user equipment 130, in the example shown in the FIGS. 1-4, the mobile user equipment is a mobile phone 130 and more in particular a smartphone 130. The mobile user equipment 130 may however also be a smart wearable or dedicated device, or a laptop or tablet or the like, as long as is comprises communication means for communicating with the electronic communication means 113 of the addon 110. In particular this communication is performed over a wireless personal area network, WPAN, more in particular a Bluetooth or Bluetooth LE network.

Preferably, the electronic communication means 113 are only then activated when the addon is activated, e.g. when the addon 110 is affixed to the proximity card 100 to form the proximity card arrangement 120 as shown in the FIG. 1.

The activation of the arrangement 120 may be initiated by tapping the addon 110, by which the addon 110 may read the authorization data from the electronic means 102 of the proximity card. This may be done electronically, in which the addon 110 reads the unique or general authorization code or token, or may alternatively also be done by a manual enrolment procedure in which the authorization data is entered manually into the registration process in which the addon is registered and in which thus the addon and the proximity card are associated.

The addon may be provided with an adhesive or adhesive glue or layer 112 to facilitate the affixing of the card 100 and addon 110. Once the cards are joint as the assembly 120 and associated accordingly, the assembly can be taken into use and the location based services and the smart (building) facilities can be employed with the assembly, through preferably a web interface serviced over the smartphone 130. The smartphone can then be used for personal and location specific services such as ordering coffee, a cleaner, a waiter, or reserving rooms or the like.

In FIG. 2, the a method 201-204 is shown, in the form of a flow card, of providing building facility services to a user, said facility services comprising providing access for said user to restricted areas within a building and additional personal building facilities relating to a particular service and location within said building. The method comprises several steps and at least the following:
In a first step 201, a proximity card is provided comprising electronic means for communication with one or a plurality of card readers within said building to provide authorization data of a user of said card to a restricted area beyond said card reader.

In the next step, 202, a proximity card addon is provided, comprising electronic communication means, arranged for communicating with said proximity card to obtain said authorization data to identify said user, and for communicating with a mobile user equipment.

In step 203, the proximity card addon and the proximity card are associated, i.e. by processing an enrolment procedure.

In the final step, 204, a facility management service application is enabled, which is running on said mobile user equipment of said user, to provide personal facility management services to said user of said mobile user equipment on the basis of the determined location of said proximity card, and said user associated through said proximity card.

The enrolment procedure in particular may introduce additional steps comprising scanning, with said mobile user equipment, an URL, preferably provided as a QR code on said proximity card addon or provided with said proximity card addon, wherein said URL comprises a unique identifier of said proximity card addon, and associating, with said mobile user equipment, through said URL on a webserver, said proximity card addon with said mobile user equipment.

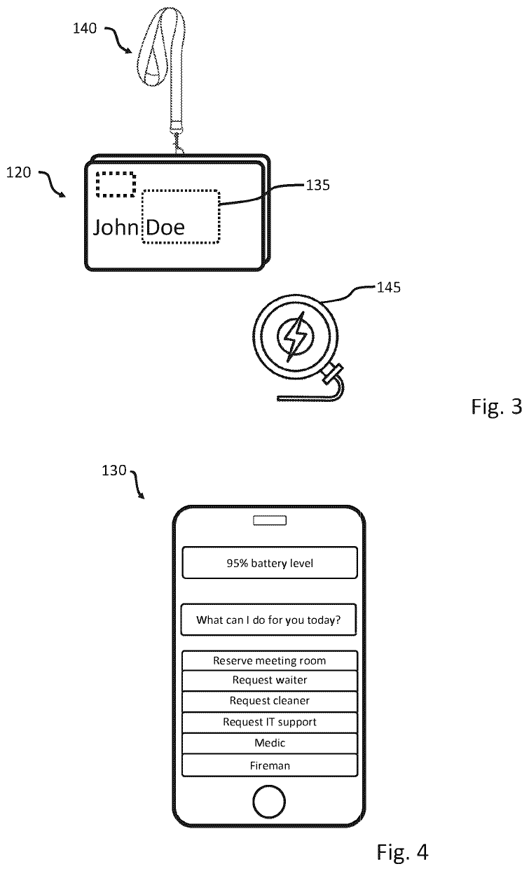

In FIG. 3 further examples are illustrated of the proximity card arrangement 120 according to the present disclosure. In the figure, the proximity card arrangement 120 and in particular the addon, may be provided with means to attach a keycord 140 such that the arrangement may be used in a similar manner as a conventional proximity card.

The addon may also be provided with a battery charging unit 135, to allow the battery to be charged when the battery is empty. The battery charging unit 135 may preferably be a wireless inductive charging unit 135 suitable for using a charging pad or inductive charging station 145 as shown in the figure.

In FIG. 4 an interface is shown of a facility management service application running on a mobile smartphone 130. The application shows, by way of illustration, a few examples of services that can be enabled with the proximity card arrangement according to the present disclosure. The interface may show buttons in which the battery level is shown of the addon, to assure that the battery is charged before it is empty. The interface further shows examples of ordering a waiter or cleaner, or issuing an IT ticket or emergency situation in which a medic and/or fireman is needed, or in which a meeting room can be reserved. In the latter example, the location of the meeting room can be determined and matched based on the proximity card location as determined by the reader in from the meeting room, which reader reads the authorization data from the proximity card. This way the user does not need to fill in all kinds of details and personal information identifying him/herself, and information regarding the room as the room info is already obtained from the reader, and the personal information is provided from the application.

Although the invention has been disclosed with reference to the above embodiments, the embodiments are not intended to limit the invention. A person of ordinary skill in the art may make some variations and improvements without departing from the spirit and scope of the invention. Therefore, the protection scope of the invention should be subject to the appended claims.

1. A proximity card addon having a ISO/IEC7810 type ID-1 formfactor, and arranged to be attached to a proximity card, said proximity card comprising:
a chargeable battery;
primary communication means, arranged for communication with a proximity card, wherein said proximity card comprising communication means arranged for Near Field Communication, NFC, with a card reader to exchange authorization data of a user of said card to a restricted area;
secondary communication means, arranged for communication with a mobile user equipment such as a mobile phone and devices within said restricted area through Wireless Personal Area Network, WPAN, communication with said mobile user equipment and said devices in said restricted area;
a controller, arranged for control of said primary and said secondary communication means, and to operate said secondary communication means in an active scanning mode, for transmitting inquiry message and receiving response messages from said devices in said restricted area, wherein said controller is further arranged for transmitting to said mobile user equipment said response messages from said devices in said restricted area.

2. The proximity card addon according to claim 1, wherein said controller is arranged for Out-Of-Band communication.

3. The proximity card addon according to claim 1, wherein said controller is arranged for Out-Of-Band communication wherein controller establishes a first communication channel over said primary communication means, initiating establishing a second communication channel over said secondary communication means, to exchange data between said mobile user equipment and said devices in said restricted area.

4. The proximity card addon according to claim 3, wherein said first communication channel is established as an NFC channel, by said proximity card addon to be in close proximity with said mobile user equipment.

5. The proximity card addon according to claim 1, wherein said controller is further arranged for transmitting to said mobile user equipment said received authorization data from said proximity card.

6. The proximity card addon according to claim 1, further comprising:
a charging unit, in electronic communication with said chargeable battery and said controller, and arranged for wireless charging of said chargeable battery.

7. The proximity card addon according to claim 1, wherein said controller is further arranged for transmitting to said mobile user equipment said authorization data of said user of said card to said restricted area, received through said primary communication means.

8. The proximity card addon according to claim 1, wherein said primary and secondary communication means are integrated into a single communication unit arranged for establishing a primary communication channel with said proximity card, and a secondary communication channel with said mobile user equipment and with said devices in said restricted area.
